(19) United States
(12) Patent Application Publication
(10) Pub. No.: US 2015/0094629 A1
(43) Pub. Date: Apr. 2, 2015

(54) COMPRESSION GARMENT CONTROLLING

(71) Applicant: Covidien LP, Mansfield, MA (US)

(72) Inventors: Peter Crowley, Norfolk, MA (US); Scott Wudyka, Marlboro, MA (US)

(73) Assignee: Covidien LP, Mansfield, MA (US)

(21) Appl. No.: 14/040,122

(22) Filed: Sep. 27, 2013

(51) Int. Cl. A61H 9/00; G05D 7/06

(52) U.S. Cl. CPC A61H 9/0078; G05D 7/0676; A61H 2201/5056
USPC 601/149; 417/425; 700/282

(57) ABSTRACT

A controller assembly for delivering pressurized fluid to a compression treatment device includes a first pump assembly including a first pump unit and a first electrical contact. The first pump assembly defines a first pneumatic passage configured for fluid communication with the pump unit. A second pump assembly includes a second pump unit and a second electrical contact. The second pump assembly defines a second pneumatic passage fluidly communicable with the second pump unit. The first pump assembly defines a receptacle into which the second pump assembly is slidingly receivable. The sliding reception of the second pump assembly into the first pump assembly establishes fluid communication between the first and second pneumatic passages and establishes electrical communication between the first and second electrical contacts.

### TECHNICAL FIELD

The present disclosure generally relates to compression garments and, more specifically, to controlling compression garments.

### BACKGROUND

Conventional vascular compression systems include a compression garment fluidly connected to a controller for cyclically inflating the compression garment. The cyclical inflation of the compression garment enhances blood circulation and decreases the likelihood of deep vein thrombosis (DVT). Controllers have traditionally been relatively large and stationed, for example, at a patient's bedside. A system of conduits connects the compression garment to the controller.

### SUMMARY

In one aspect, a controller assembly for delivering pressurized fluid to a compression treatment device includes a first pump assembly including a first pump unit and a first electrical contact. The first pump assembly defines a first pneumatic passage configured for fluid communication with the pump unit. A second pump assembly includes a second pump unit and a second electrical contact. The second pump assembly defines a second pneumatic passage fluidly communicable with the second pump unit. The first pump assembly defines a receptacle into which the second pump assembly is slidingly receivable. The sliding reception of the second pump assembly into the first pump assembly establishes fluid communication between the first and second pneumatic passages and establishes electrical communication between the first and second electrical contacts.

In some embodiments, the second pump assembly includes a controller including computer-executable instructions and a processor configured to execute the computer-executable instructions. The computer-executable instructions include instructions to control the first and second pump assemblies when the second pump assembly is fluidly and electrically connected to the first pump assembly.

In certain embodiments, the second pump assembly includes a controller including computer-executable instructions and a processor configured to execute the computer-executable instructions. The computer-executable instructions include instructions to control the second pump assembly when the second pump assembly is fluidly and electrically disconnected from the first pump assembly.

In some embodiments, the second pump assembly includes a controller including computer-executable instructions and a processor configured to execute the computer-executable instructions. The computer-executable instructions include instructions to deliver pressurized fluid from the first or second pump unit to a compression garment in fluid communication with the second pump assembly.

In certain embodiments, the computer-executable instructions further include instructions to deliver sequential compression therapy to a plurality of bladders of the compression garment in fluid communication with the second pump assembly.

In some embodiments, the second pump assembly further includes a user interface electrically coupled to the controller.

In certain embodiments, pressurized fluid from the first pump unit is movable into the second pneumatic passage when the second pump assembly is received in the receptacle of the first pump assembly.

In some embodiments, the second pump assembly passage further defines an exhaust passage in fluid communication with the second pneumatic passage and vents to atmosphere when the second pump assembly is fluidly connected to the first pump assembly.

In certain embodiments, the second pump unit is bypassed when the second pump assembly is received in the receptacle defined by the first pump assembly.

In some embodiments, the first pump assembly further includes one or more guides disposed along the receptacle. The second pump assembly is engagable with the one or more guides such that the second pump assembly is aligned relative to the first pump assembly as the second pump assembly moves into fluid and electrical connection with the first pump assembly.

In certain embodiments, the assembly further includes a locking system including a first locking portion on the first pump assembly and a second locking portion on the second pump assembly. The first and second locking portions are securable to one another to lock the second pump assembly to the first pump assembly when the second pump assembly is received in the receptacle of the first pump assembly.

In some embodiments, the assembly further includes a bypass switch wherein, when the second pump assembly is received in the receptacle of the first pump assembly, the bypass switch is in fluid communication with the first pneumatic passage and the second pneumatic passage and operable to bypass the second pump unit.

In certain embodiments, the second pump assembly includes a battery power source rechargeable through the electrical communication between the first and second electrical contacts.

In some embodiments, the second pump assembly further defines a fluid outlet. The first pneumatic passage is placed in fluid communication with the fluid outlet when the second pump assembly is slidingly received in the receptacle of the first pump assembly.

In another aspect, a therapeutic compression system includes a first pump assembly including a first pump unit and a first electrical contact. The first pump assembly defines a first pneumatic passage configured for fluid communication with the pump unit. A second pump assembly includes a second pump unit, and a second electrical contact. The second pump assembly defines a second pneumatic passage configured for fluid communication with the second pump unit. A compression garment is positionable about a limb of a wearer. The compression garment includes one or more inflatable bladders. The compression garment is mechanically couplable to the second pump assembly such that the one or more inflatable bladders are in fluid communication with the second passage. The first pump assembly defines a receptacle into which the second pump assembly is slidingly receivable while the one or more inflatable bladders are in fluid communication with the second passage. The sliding reception of the second pump assembly into the first pump assembly establishes fluid communication between the first and second pneumatic passages and establishes electrical communication between the first and second electrical contacts.

In certain embodiments, the fluid communication between the first and second pneumatic passages and the electrical communication between the first and second electrical contacts are simultaneously established by the sliding reception of the second pump assembly into the first pump assembly.

In some embodiments, the first and second pump units can be used in parallel when the first and second pump assemblies are in pneumatic and electrical communication with one another. For example, the first and second pump units can supply pressurized air during different portions of a compression cycle.

Embodiments can include one or more of the following advantages.

In certain embodiments, pneumatic and electrical communication is simultaneously established when first and second pump assemblies are connected. Such simultaneous establishment of pneumatic and electrical communication can, for example, reduce the likelihood of interruptions to compression treatment as the source of pressurized fluid (e.g., air) is switched between the first and second pump assemblies. In some instances, this can facilitate the use of the second pump assembly as a portable source of pressurized fluid, while providing the option to use the first pump assembly as a source of pressurized fluid for extended use and/or while a battery power source of the second pump assembly is recharged. Additionally or alternatively, the simultaneous establishment of pneumatic and electrical communication when the first and second pump assemblies are connected can facilitate autonomous use of the compression system by the wearer (e.g., with little or no assistance required from a care giver).

In some embodiments, a compression treatment system is configurable in both a portable and a stationary configuration. The option to provide pressurized fluid to a compression garment in either a portable or stationary configuration can, for example, increase patient compliance with the prescribed use of the compression garment. For example, by facilitating the continued supply of pressurized fluid from a portable supply of pressurized fluid, the wearer has the option of continuing to wear the compression garment as the wearer moves about (e.g., walks). This can lead to an increase in compliance as compared to the use of compression systems that are entirely reliant on a stationary source of pressurized fluid.

In some embodiments, the removability of the second pump assembly from the first pump assembly can facilitate the repair and/or replacement of one or both of the first and second pump assemblies. Additionally or alternatively, the removability of the second pump assembly from the first pump assembly can facilitate interchangeability of components such that a wearer can connect the second pump assembly to any of a number of distributed first pump assemblies (e.g., first pump assemblies distributed at various locations within a healthcare facility).

Other aspects, features, and advantages will be apparent from the description and drawings, and from the claims.

### BRIEF DESCRIPTION OF THE DRAWINGS

FIG. 1 is a schematic of a compression system including a perspective view of a controller assembly and a front view of a compression garment with an outer cover and intermediate layers of the compression garment partially removed to show underlying layers.

FIG. 2 is a perspective view of the controller assembly of FIG. 1, showing a first pump assembly receiving a second pump assembly.

FIG. 3 is a perspective view of a first pump assembly of the controller assembly of FIG. 1.

FIG. 4 is the perspective view of FIG. 2, with internal construction of the first and second pump assemblies of FIG. 2 represented in phantom lines.

FIG. 4A is a fragmentary perspective view of the controller assembly of FIG. 4, with an exhaust passage system schematically illustrated.

FIG. 5 is a rear perspective view of the second pump assembly of the controller assembly of FIG. 1.

FIG. 6 is the perspective view of FIG. 5, with an exploded view of a battery compartment of the second pump assembly of the controller assembly of FIG. 1.

FIG. 7 is an exploded perspective of a second pump assembly of a controller assembly.

FIG. 8 is an exploded perspective view of a controller assembly, showing a first pump assembly disconnected from a second pump assembly.

FIG. 9 is a perspective view of the controller assembly of FIG. 8, with the first and second pump assemblies shown connected to one another.

Corresponding reference characters indicate corresponding parts throughout the drawings.

### DETAILED DESCRIPTION

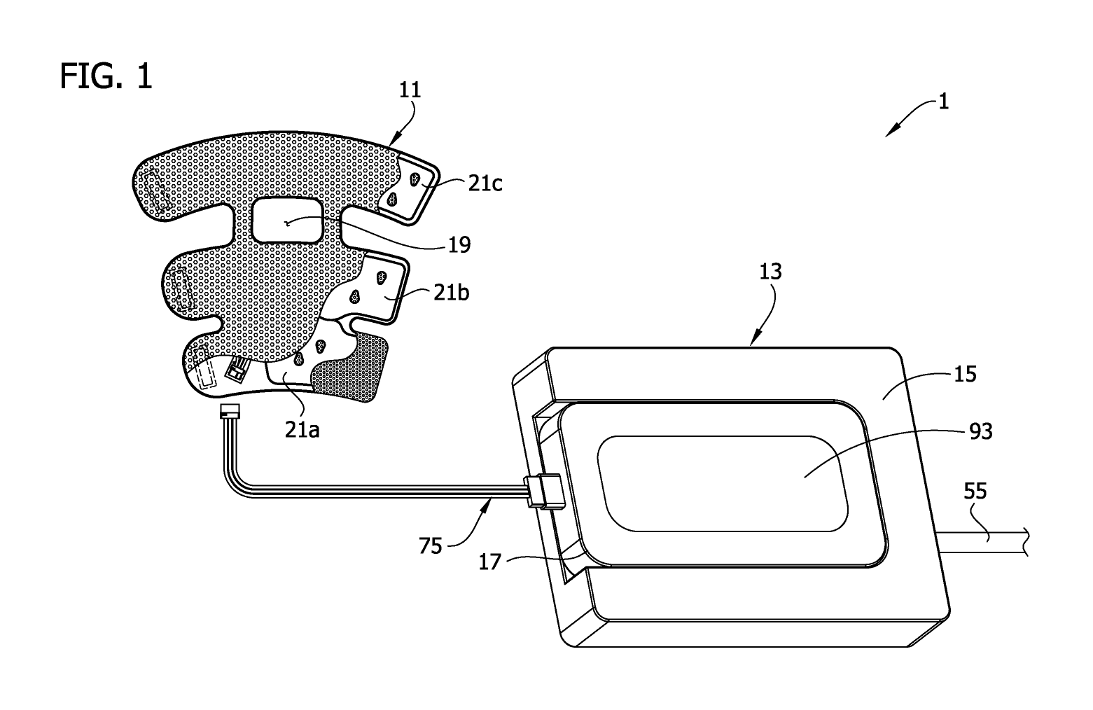

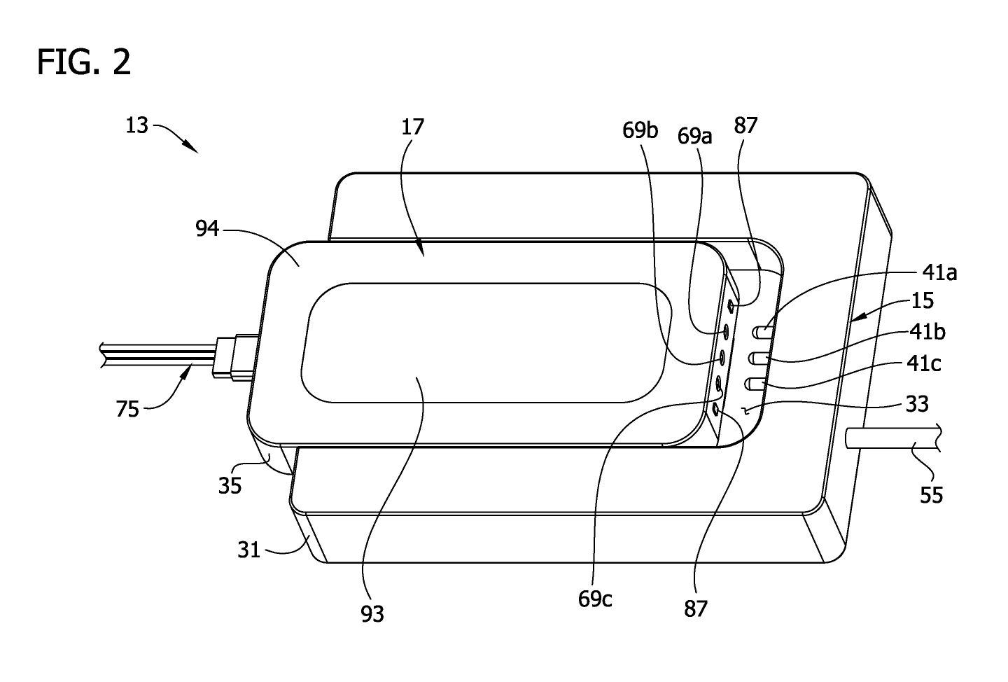

Referring now to FIGS. 1 and 2, a compression treatment system 1 includes a compression garment 11 for applying sequential compression therapy to a limb of a wearer, and a controller assembly 13 for controlling operation of the compression garment 11. The controller assembly 13 includes a first pump assembly 15 and a second pump assembly 17. As described in further detail below, the second pump assembly 17 is slidingly receivable into the first pump assembly 15 to establish fluid and electrical communication between the first and second pump assemblies 15, 17. As will also be described in further detail below, the second pump assembly 17 operates the compression garment 11 for applying compression therapy to a limb of a wearer when the second pump assembly 17 is received in the first pump assembly 15 and when the second pump assembly 17 is removed from the first pump assembly. With the second pump assembly 17 removed from the first pump assembly 15, the compression system 1 can be used as a “portable” compression system. With the second pump assembly 17 pneumatically and electrically coupled to the first pump assembly 15, the compression system 1 can be used as a “stationary” compression system providing, for example, a consistent source of pressurized air and charging one or more battery components carried by the second pump assembly 17.

The compression garment 11 can be a sleeve sized and shaped for being disposed around a leg of a wearer's body. For example, the compression garment 11 can have a width for being wrapped around a full circumference of the leg and a length extending from an ankle to a thigh of the leg. The compression garment 11 can define a knee opening 19 for general alignment with the back of the knee when the compression garment 11 is worn. The compression garment 11 can include a plurality of inflatable bladders 21a, 21b, 21c for providing sequential compression therapy, for example, to a wearer's leg. This type of garment is generally referred to as a thigh-length garment. It will be understood, however, that the compression garment 11 may come in different sizes and/or may have greater or fewer inflatable bladders. For example, the compression garment 11 can be a knee length garment that extends from the ankle to the calf of the leg. Additionally or alternatively, the compression garment 11 can be positionable about other parts of the wearer's body. For example, the compression garment 11 can be a foot cuff. While the compression garment 11 is described herein as applying sequential therapy, it should be further appreciated that the compression garment can additionally or alternatively apply a constant compression therapy.

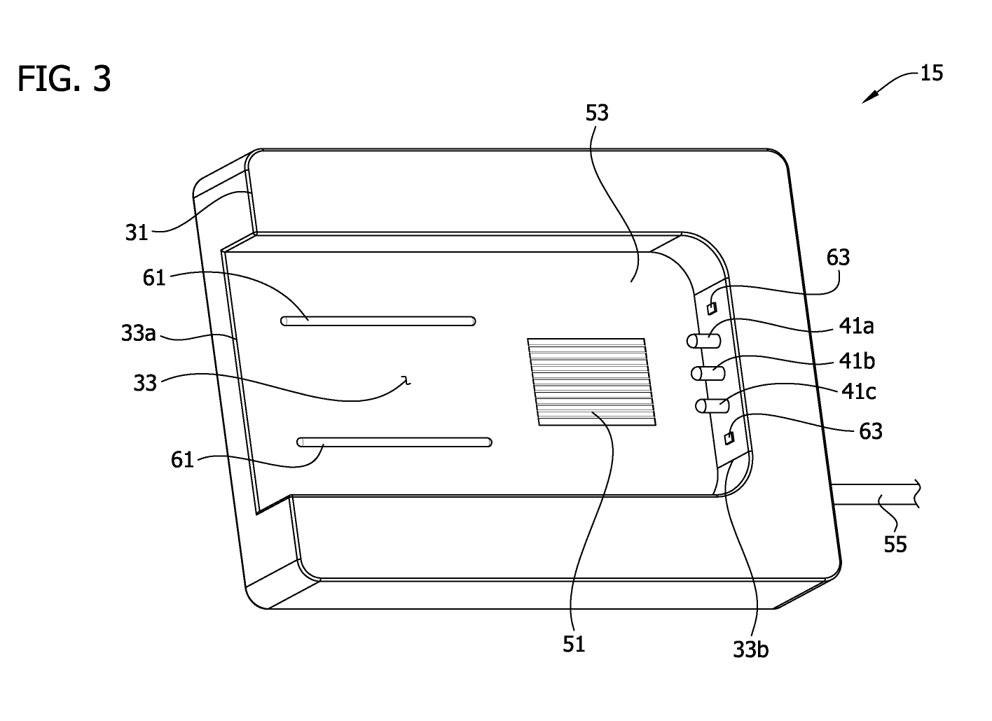

Referring to FIGS. 2-4, the first pump assembly 15 includes a housing 31 defining a receptacle 33. The receptacle 33 has an open end 33a and a closed end 33b. The second pump assembly 17 includes a housing 35 slidingly receivable into the receptacle 33 through the open end 33a of the receptacle 33. The second pump assembly 17 can be slid along the receptacle 33 until an end of the second pump assembly 17 reaches the closed end 33b of the receptacle 33.

The housing 31 of the first pump assembly 15 houses a first pump unit 37 for supplying fluid to first pneumatic passages 39a, 39b, 39c at least partially disposed in the housing 31 of the first pump assembly 15. The first pump unit 37 can be a DC-powered compressor such as a diaphragm piston, rolling diaphragm, piezo-electric, or impeller type compressor. Additionally or alternatively, the first pump unit 37 can provide variable air flow from 0 to 15 liters per minute at pressures up to about 220 mmHg. For example, the first pump unit 37 can include a positive displacement pump sized to provide about 45 mmHg, about 40 mmHg, and about 30 mmHg of air to the inflatable bladders 21a, 21b, 21c. For example, the first pump unit 37 can provide pressurized air to the inflatable bladders 21a, 21b, 21c in one or more of a sequential, gradient, and circumferential manner. It should be appreciated that, as compared to sources of pressurized air typically found near patient beds in healthcare facilities (e.g., through the wall or through a pressurized canister), the first pump unit 37 can provide a more consistent source of pressurized air at the pressures desired for compression therapy. Moreover, the first pump unit 37 can facilitate use of the compression treatment system 1 in areas in which other sources of pressurized air may not be available.

The first pneumatic passages 39a, 39b, 39c are partially defined by respective nipples 41a, 41b, 41c extending from the first pump unit 37 into the receptacle 33. A first electrical contact 51 is disposed on a floor 53 of the receptacle 33. In some embodiments, the first electrical contact 51 includes a plate disposed along the floor 53 of the receptacle 33. In certain embodiments, the first electrical contact 51 includes a male/female electrical pin connection. The first pump assembly 15 includes a power cord 55 for supplying power to the first pump assembly 15 and/or to the second pump assembly 17 (e.g., when the second pump assembly 17 is disposed in the receptacle 33 of the first pump assembly 15). The first pump assembly 15 may, additionally or alternatively, include a large capacity battery for powering the first pump assembly 15 (e.g., as an emergency back-up in the event of a power failure) and/or the second pump assembly 17 when the second pump assembly 17 is disposed in the receptacle 33 of the first pump assembly 15.

One or more first guides 61 are disposed along the floor 53 of the receptacle 33. The first guides 61 extend generally along a length of the receptacle 33 in a direction extending from the open end 33a to the closed end 33b. As will be explained in greater detail below, the guides 61 align the second pump assembly 17 relative to the first pump assembly 15 as the second pump assembly 17 slides into the receptacle 33 of the first pump assembly 15. Locking elements 63 are disposed at the closed end 33b of the receptacle 33 and, as described in further detail below, engage the second pump assembly 17 to releasably secure the second pump assembly 17 to the first pump assembly 15 when the second pump assembly 17 is disposed in the receptacle 33 of the first pump assembly 15. The locking elements 63 can, for example, reduce the likelihood of damage to the nipples 41a, 41b, 41c. Additionally or alternatively, the locking elements 63 can reduce the likelihood that pneumatic and/or electrical communication between the first pump assembly 15 and the second pump assembly 17 can be inadvertently interrupted.

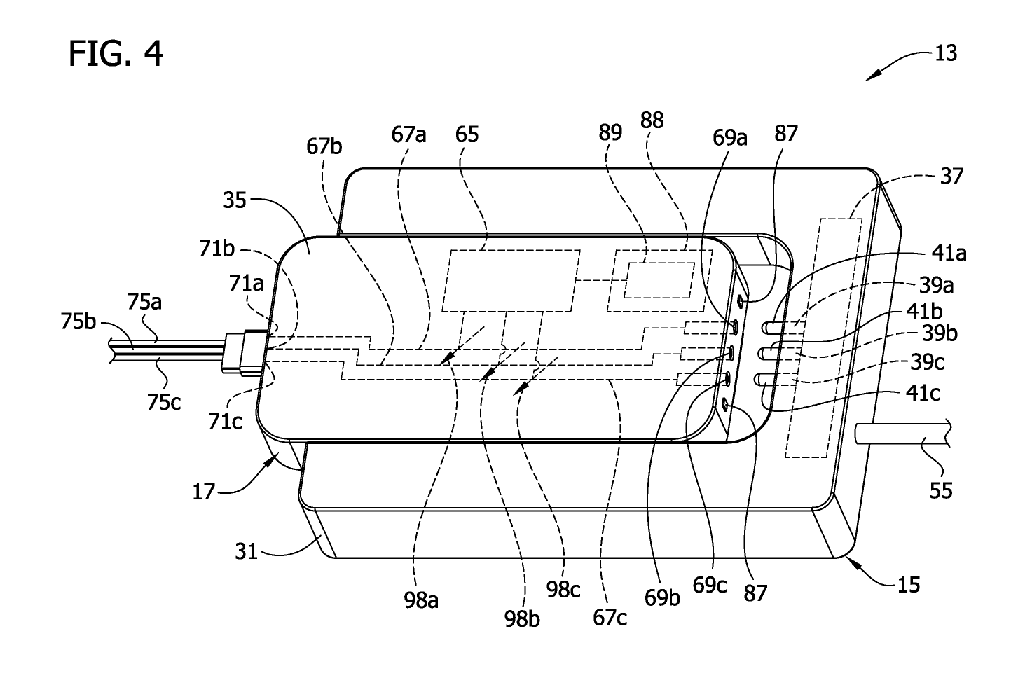

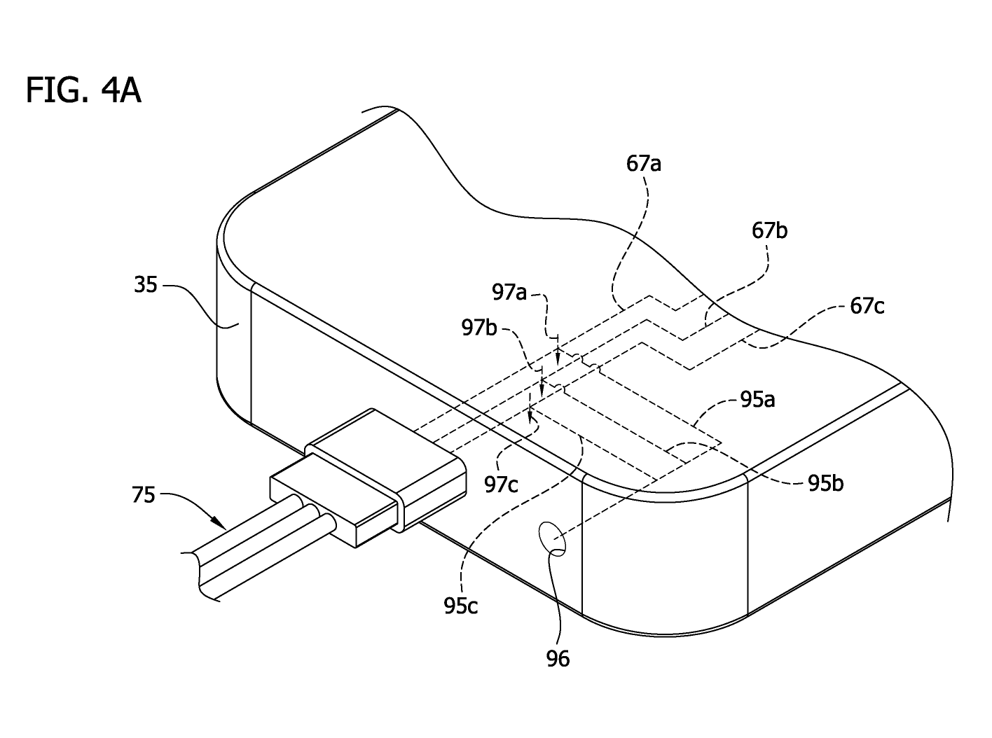

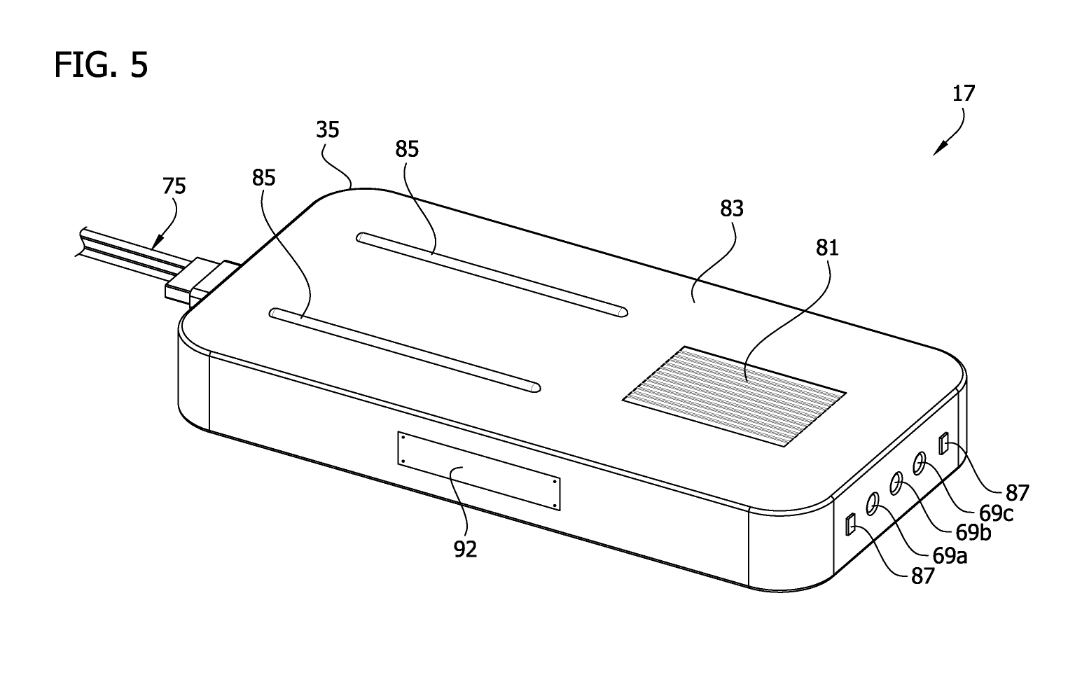

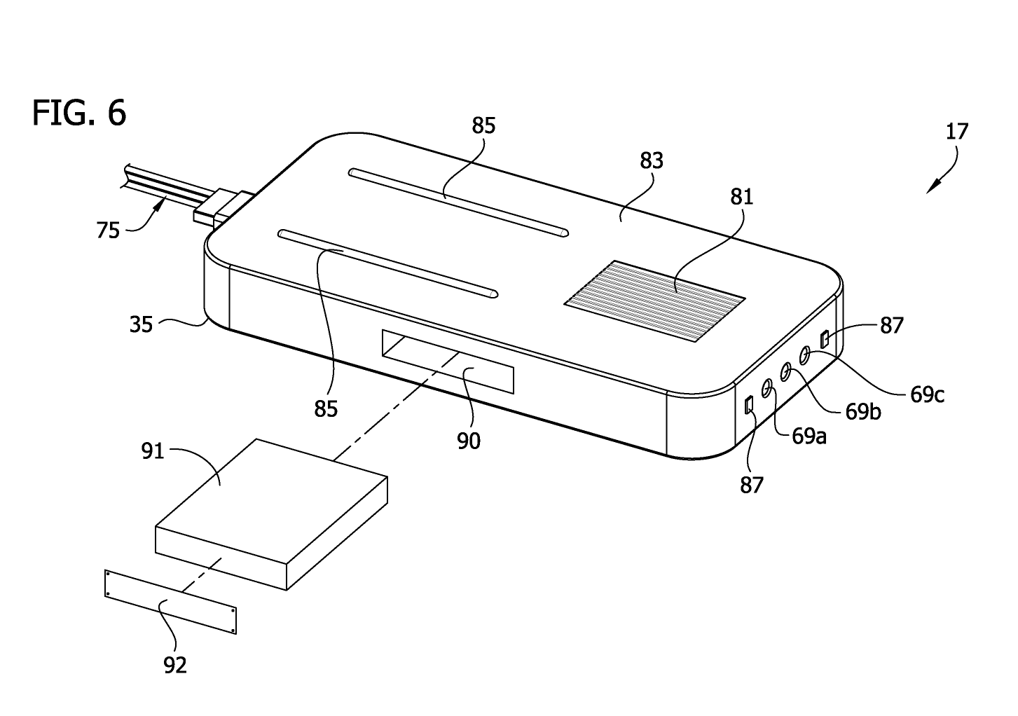

Referring to FIGS. 4-6, the housing 35 of the second pump assembly 17 houses a second pump unit 65 for supplying fluid to second pneumatic passages 67a, 67b, 67c disposed in the housing 35 of the second pump assembly 17. Ports 69a, 69b, 69c are in fluid communication with respective second pneumatic passages 67a, 67b, 67c. Nipples 41a, 41b, 41c of the first pump assembly 15 are receivable into the respective ports 69a, 69b, 69c to place the first pneumatic passages 39a, 39b, 39c in fluid communication with the second pneumatic passages 67a, 67b, 67c. The second pneumatic passages 67a, 67b, 67c include respective outlets 71a, 71b, 71c connectable to respective conduits 75a, 75b, 75c for fluidly coupling outlets 71a, 71b, 71c to the respective bladders 21a, 21b, 21c of the compression garment 11.

A second electrical contact 81 is disposed along a bottom portion 83 of the housing 35 of the second pump assembly 17. In one embodiment, the second electrical contact 81 includes a plate disposed along the bottom 83 of the housing 35. In certain embodiments, the second electrical contact 81 additionally or alternatively includes a male/female electrical pin connection.

One or more second guides 85 are disposed along the bottom portion 83 of the housing 35 and extend generally along a length of the housing 35. The one or more second guides 85 are engageable with the one or more first guides 61 on the first pump assembly 15 to align the second pump assembly 17 relative to the first pump assembly 15 as the second pump assembly 17 slides in the receptacle 33 of the first pump assembly 15. In some embodiments, the one or more first guides 61 and the one or more second guides 85 each include ribs. For example, the one or more first guides 61 and the one or more second guides 85 can include ribs laterally offset from each other such that the ribs of the one or more first guides 61 are engageable with the ribs of the one or more second guides 85 as the second pump assembly 17 slides into the receptacle 33 of the first pump assembly 15. The engagement of the ribs can, for example, inhibit canting of the second pump assembly 17 in the receptacle 13.

Second locking elements 87 are disposed at an end of the housing 35 of the second pump assembly 17. The second locking elements 87 are engageable with the first locking elements 63 of the first pump assembly 15 to secure the second pump assembly 17 in the receptacle 33 of the first pump assembly 15. In one embodiment, the first and second locking elements 63, 87 include complimentary magnetic portions. Additionally or alternatively, the first and second locking elements 63, 87 can include mechanical levers and/or components sized for interference fitting with one another. It should be appreciated that the first and second locking elements 63, 87 can be used for fine positional adjustment of the second pump assembly 17 relative to the first pump assembly 15. Such fine positional adjustment can, for example, reduce the likelihood of damage to the nipples 41a, 41b, 41c as the second pump assembly 17 slides into engagement with the nipples 41a, 41b, 41c.

The second pump assembly 17 further includes a controller 88 for controlling operation of the compression system 1. The controller 88 includes computer-readable instructions for controlling the pump assemblies 15, 17 and a processor 89 configured to execute the computer readable instructions. As will be explained in greater detail below, the computer-readable instructions include instructions to control the first and second pump assemblies 15, 17 when the second pump assembly 17 is fluidly and electrically connected to the first pump assembly 15. The computer-readable instructions can additionally or alternatively include instructions to control the second pump assembly 17 when the second pump assembly 17 is disconnected from the first pump assembly 15.

A battery compartment 90 is defined by the housing 35 of the second pump assembly 17. The battery compartment 90 houses a battery 91 for powering the second pump assembly 17 when the second pump assembly is disconnected from the first pump assembly 15. Additionally or alternatively, the battery 91 can power the first pump assembly 15 and the second pump assembly 17 when the first pump assembly 15 is without power (e.g., in the event of a power outage in a healthcare facility).

A panel 92 secures the battery 91 in the battery compartment 89. The panel 92 can be removable (e.g., through the use of tools) to facilitate access to the battery 91 for repair and/or replacement. Additionally or alternatively, the panel 92 can facilitate access to the second pump unit 65 such that the second pump unit 65 for repair and/or replacement.

A user interface 93 (FIGS. 1 and 2) is disposed on a front 94 of the housing 35 and is capable of displaying information such as information about the status and operation of the compression system 1. The user interface 93 can be electrically connected to the controller 88 to allow a user to control the operation of the compression system 1. The user interface 93 can include one or more graphical display subcomponents. For example, the user interface 93 may be a graphical user interface having a touch screen by which the user can provide the input information.

Sliding reception of the second pump assembly 17 into the receptacle 33 results in the nipples 41a, 41b, 41c of the first pump assembly 15 being received in respective ports 69a, 69b, 69c in the second pump assembly 17 when the second pump assembly 17 is fully received in the receptacle 33 of the first pump assembly 15. The connection of the nipples 41a, 41b, 41c with the ports 69a, 69b, 69c establishes the pneumatic connection between the pump assemblies 15, 17. Fluid supplied by the first pump unit 37 in the first pump assembly 15 can be delivered through the first pneumatic passages 39a, 39b, 39c into the second pneumatic passages 67a, 67b, 67c in the second pump assembly 17 in this connected configuration. Fluid in the second pneumatic passages 67a, 67b, 67c can be directed (e.g., under pressure produced by the first pump unit 37) to the outlets 71a, 71b, 71c of the respective second pneumatic passages 67a, 67b, 67c and into the respective conduits 75a, 75b, 75c for delivery to the bladders 21a, 21b, 21c of the compression garment 11 (FIG. 1). The controller 88 in the second pump assembly 17 can include computer-executable instructions to instruct the first pump unit 37 to deliver fluid to the bladders 21a, 21b, 21c of the compression garment 11 to apply, for example, sequential compression therapy to the limb of the wearer.

Referring to FIG. 4A, the second pump assembly 17 further defines exhaust passages 95a, 95b, 95c in selective fluid communication with respective second pneumatic passages 67a, 67b, 67c. The exhaust passages 95a, 95b, 95c extend from the respective second pneumatic passages 67a, 67b, 67c to an exhaust opening 96 defined by the housing 35 of the second pump assembly 17 such that the exhaust opening 96 vents to atmosphere. Exhaust valves 97a, 97b, 97c are in fluid communication with respective exhaust passages 95a, 95b, 95c. The controller 88 is in electrical communication with each of the exhaust valves 97a, 97b, 97c and includes computer-executable instructions to position the exhaust valves 97a, 97b, 97c to vent the exhaust passages 95a, 95b, 95c to atmosphere. For example, the exhaust valves 97a, 97b, 97c can be positioned to vent the exhaust passages 95a, 95b, 9c to atmosphere to deflate one or more of the bladders 21a, 21b, 21c of the compression garment 11 (e.g., as part of sequential compression therapy).

The sliding reception of the second pump assembly 17 into the first pump assembly 15 can additionally or alternatively establish an electrical connection between the first and second electrical contacts 51, 81. For example, the sliding reception of the second pump assembly 17 into the first pump assembly 15 can result in substantially simultaneously establishing pneumatic and electrical communication between the first pump assembly 15 and the second pump assembly 17. As used herein, substantially simultaneous establishment of pneumatic and electrical communication between the first pump assembly 15 and the second pump assembly 17 can include establishment of pneumatic and electrical communication through movement of the second pump assembly 17 relative to the first pump assembly 15 (e.g., sliding movement of the second pump assembly 17 along the receptacle 33). As another nonexclusive example, substantially simultaneous establishment of pneumatic and electrical communication between the first pump assembly 15 and the second pump assembly 17 can include establishing pneumatic and electrical communication along the receptacle 33 of the first pump assembly 15. As yet another nonexclusive example, substantially simultaneous establishment of pneumatic and electrical communication between the first pump assembly 15 and the second pump assembly 17 can include establishment of pneumatic and electrical communication without separate manipulation of the first pump assembly 15 and/or the second pump assembly 17, beyond the connection of the second pump assembly 17 to the first pump assembly 15, to establish one or the other of the pneumatic and electrical communication.

In some embodiments, the controller 88 in the second pump assembly 17 can send operational commands to the first pump assembly 15 through the electrical connection between the first pump assembly 15 and the second pump assembly 17. For example, the controller 88 can control operation of the first pump unit 37 in the first pump assembly 15 when the first and second pump assemblies 15, 17 are electrically connected. In some embodiments, the controller 88 energizes the first pump unit 37 when the second pump assembly 17 is electrically connected to the first pump assembly 15. Additionally or alternatively, the electrical connection between the first and second pump assemblies 15, 17 can be used to transfer data between the pump assemblies 15, 17, calibrate the pump assemblies 15, 17, and/or charge the battery 91 in the second pump assembly 17.

Bypass valves 98a, 98b, 98c in the second pump assembly 17 are in fluid communication with respective second pneumatic passages 67a, 67b, 67c. The bypass valves 98a, 98b, 98c can close off the second pump unit 65 from fluid communication with the outlets 71a, 71b, 71c of the second pneumatic passages 67a, 67b, 67c when the second pump assembly 17 is fully received in the receptacle 33 of the first pump assembly 15. For example, the bypass valves 98a, 98b, 98c can direct fluid such that fluid from only the first pump unit 37 is delivered to the compression garment 11 when the second pump assembly 17 is connected to the first pump assembly 15. Additionally or alternatively, the bypass valves 98a, 98b, 98c can be electrically connected to the controller 88 in the second pump assembly 17, and the controller 88 can include computer-executable instructions to actuate the bypass valves 98a, 98b, 98c once electrical connection is established with the first pump assembly 15. In some embodiments, the controller 88 in the second pump assembly 17 turns off the second pump unit 65 once electrical connection is established between the second pump assembly 17 and the first pump assembly 15. In certain embodiments, engagement of the locking elements 63, 87 signals to the controller 88 to turn off the second pump unit 65. Additionally or alternatively, fluid pressure from fluid supplied by the first pump unit 37 can shut the bypass valves 98a, 98b, 98c, blocking the flow of fluid from the second pump unit 65 to the outlets 71a, 71b, 71c of the second pneumatic passages 67a, 67b, 67c.

Disengaging the second pump assembly 17 from the first pump assembly 15 disconnects the pneumatic and electrical connections between the first and second pump assemblies 15, 17. Upon such disconnection of the second pump assembly 17 from the first pump assembly 15, the bypass valves 98a, 98b, 98c are actuated to place the second pump unit 65 in fluid communication with the outlets 71a, 71b, 71c of the second pneumatic passages 67a, 67b, 67c. In this disconnected configuration, the second pump unit 65 supplies fluid to the compression garment 11. The controller 88 in the second pump assembly 17 includes computer-executable instructions to actuate the bypass valves 98a, 98b, 98c upon interruption of the electrical connection between the first and second pump assemblies 15, 17. Additionally or alternatively, the controller 88 can include computer-executable instructions to turn on the second pump unit 65 upon interruption of the electrical connection between the first and second pump assemblies 15, 17. Additionally or alternatively, the removal of fluid pressure from fluid supplied by the first pump unit 37 in the first pump assembly 15 can allow the bypass valves 98a, 98b, 98c to move to establish fluid communication between the second pump unit 65 and the outlets 71a, 71b, 71c of the second pneumatic passages 67a, 67b, 67c.

In general, the second pump assembly 17 is smaller than the first pump assembly 15 such that the smaller second pump assembly 17 is more easily portable, facilitating user mobility while compression therapy is being provided in the disconnected configuration of the first and second pump assemblies 15, 17. The second pump unit 65 can be a DC-powered compressor such as a diaphragm piston, rolling diaphragm, piezo-electric, or impeller type compressor. Additionally or alternatively, the first pump unit 37 can provide variable air flow from 0 to 15 liters per minute at pressures up to about 220 mmHg. For example, the second pump unit 65 can be sized to deliver fluid to the compression garment 11 at a pressure of at least up to about 45 mmHg for supplying sufficient pressure to the bladders 21a, 21b, 21c of the compression garment 11 to provide adequate compression treatment to the wearer's limb as part of a compression therapy treatment.

While certain embodiments have been described, other embodiments are possible.

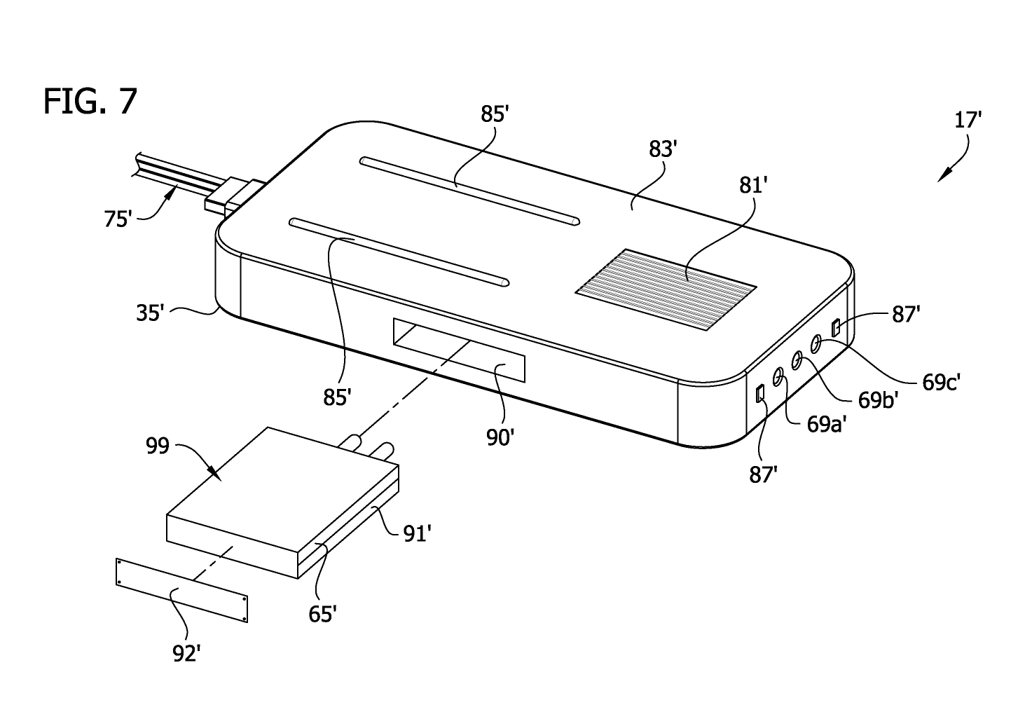

For example, while a battery and a second pump unit have been described as separate units accessible for repair and/or replacement, other configurations are additionally or alternatively possible. For example, referring to FIG. 7, a second pump assembly 17′ includes a cartridge 99 including a second pump unit 65′ for supplying fluid to a compression garment, and a battery 91′ for powering the second pump assembly 17′. The cartridge 99 facilitates removal and/or replacement of the pump unit component 65′ and battery component 91′. A controller (e.g., a controller similar to controller 88 shown in FIG. 4) carried by the second pump assembly 17′ can include computer executable instructions to monitor the use time of the cartridge 99 and/or run diagnostic tests on either or both of the pump unit component 65′ and battery component 91′ to assess whether replacement of the cartridge 99 is needed. Being able to replace the cartridge 99 may facilitate in-field repair and reduce the likelihood of downtime associated with maintenance of the second pump assembly 17′. Additionally or alternatively, the cartridge 99 can facilitate the incorporation of hardware and/or software upgrades to the second pump assembly 17′. The function of the second pump assembly 17′ is otherwise the same as second pump assembly 17. Accordingly, like components are indicated by corresponding reference numerals followed by a prime.

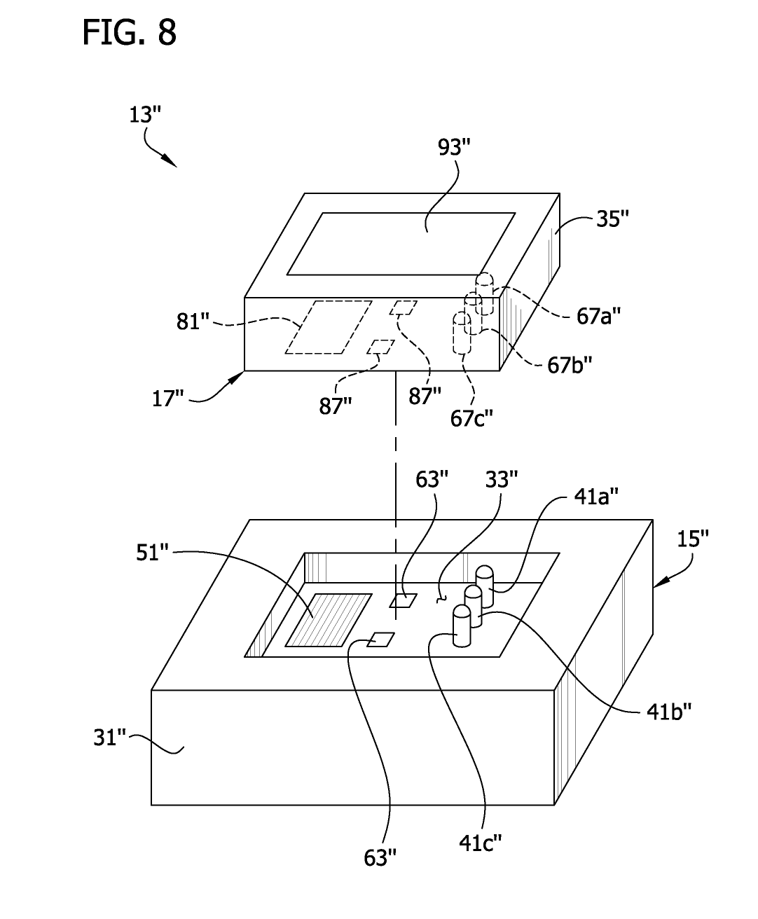

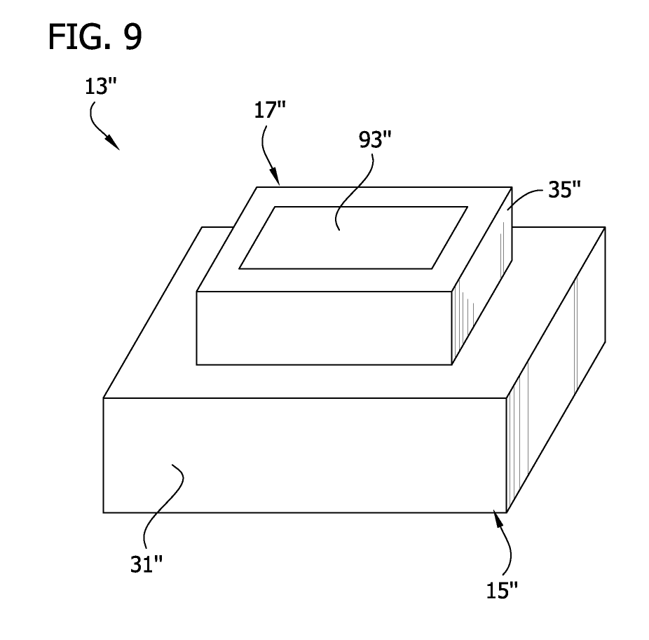

As another example, while a second pump assembly has been described as being horizontally movable into engagement with a first pump assembly, other configurations are additionally or alternatively possible. For example, referring to FIGS. 8 and 9, a controller assembly 13″ includes a first pump assembly 15″ and a second pump assembly 17″. The first pump assembly 15″ defines a receptacle 33″ having an opening along a top surface of the first pump assembly 15″ when the first pump assembly 15″ is in use. The second pump assembly 17″ is connected to the first pump assembly 15″ by moving the second pump assembly 17″ into the receptacle 33″ along a substantially vertical axis. This orientation of the receptacle 33″ for vertically receiving the second pump assembly 17″ can facilitate connection of the second pump assembly 17″ to the first pump assembly 15″. For example, a person wearing a compression garment 11 may have limited mobility that may make a vertical connection between the first pump assembly 15″ and the second pump assembly 17″ preferable. The function of the controller assembly 13″ is otherwise the same as controller assembly 13. Accordingly, like components are indicated by corresponding reference numerals plus a double prime.

A number of embodiments have been described. Nevertheless, it will be understood that various modifications may be made without departing from the spirit and scope of the disclosure. Accordingly, other embodiments are within the scope of the following claims.

What is claimed is:

1. A controller assembly for delivering pressurized fluid to a compression treatment device, the controller assembly comprising:
a first pump assembly including a first pump unit and a first electrical contact, the first pump assembly defining a first pneumatic passage configured for fluid communication with the pump unit; and
a second pump assembly including a second pump unit and a second electrical contact, the second pump assembly defining a second pneumatic passage fluidly communicable with the second pump unit;
the first pump assembly defining a receptacle into which the second pump assembly is slidingly receivable, the sliding reception of the second pump assembly into the first pump assembly establishing fluid communication between the first and second pneumatic passages and establishing electrical communication between the first and second electrical contacts.

2. The controller assembly of claim 1, wherein the second pump assembly includes a controller comprising computer-executable instructions and a processor configured to execute the computer-executable instructions, the computer-executable instructions comprising instructions to control the first and second pump assemblies when the second pump assembly is fluidly and electrically connected to the first pump assembly.

3. The controller assembly of claim 1, wherein the second pump assembly includes a controller comprising computer-executable instructions and a processor configured to execute the computer-executable instructions, the computer-executable instructions comprising instructions to control the second pump assembly when the second pump assembly is fluidly and electrically disconnected from the first pump assembly.

4. The controller assembly of claim 1, wherein the second pump assembly includes a controller comprising computer-executable instructions and a processor configured to execute the computer-executable instructions, the computer-executable instructions comprising instructions to deliver pressurized fluid from the first or second pump unit to a compression garment in fluid communication with the second pump assembly.

5. The controller assembly of claim 4, wherein the computer-executable instructions further comprise instructions to deliver sequential compression therapy to a plurality of bladders of the compression garment in fluid communication with the second pump assembly.

6. The controller assembly of any of claims 2-5, wherein the second pump assembly further comprises a user interface electrically coupled to the controller.

7. The controller assembly of claim 1, wherein pressurized fluid from the first pump unit is movable into the second pneumatic passage when the second pump assembly is received in the receptacle of the first pump assembly.

8. The controller assembly of claim 1, wherein the second pump assembly passage further defines an exhaust passage in fluid communication with the second pneumatic passage and venting to atmosphere when the second pump assembly is fluidly connected to the first pump assembly.

9. The controller assembly of claim 1, wherein the second pump unit is bypassed when the second pump assembly is received in the receptacle defined by the first pump assembly.

10. The controller assembly of claim 1, wherein the first pump assembly further includes one or more guides disposed along the receptacle, the second pump assembly engagable with the one or more guides such that the second pump assembly is aligned relative to the first pump assembly as the second pump assembly moves into fluid and electrical connection with the first pump assembly.

11. The controller assembly of claim 1, further comprising a locking system including a first locking portion on the first pump assembly and a second locking portion on the second pump assembly, the first and second locking portions securable to one another to lock the second pump assembly to the first pump assembly when the second pump assembly is received in the receptacle of the first pump assembly.

12. The controller assembly of claim 1, further comprising a bypass valve wherein, when the second pump assembly is received in the receptacle of the first pump assembly, the bypass valve is in fluid communication with the first pneumatic passage and the second pneumatic passage and operable to bypass the second pump unit.

13. The controller assembly of claim 1, wherein the second pump assembly includes a battery power source rechargeable through the electrical communication between the first and second electrical contacts.

14. The controller assembly set forth in claim 1, wherein the second pump assembly further defines a fluid outlet, the first pneumatic passage placed in fluid communication with the fluid outlet when the second pump assembly is slidingly received in the receptacle of the first pump assembly.

15. A therapeutic compression system comprising:
a first pump assembly including a first pump unit and a first electrical contact, the first pump assembly defining a first pneumatic passage configured for fluid communication with the pump unit; and
a second pump assembly including a second pump unit, and a second electrical contact, the second pump assembly defining a second pneumatic passage configured for fluid communication with the second pump unit;
a compression garment positionable about a limb of a wearer, the compression garment comprising one or more inflatable bladders, the compression garment mechanically couplable to the second pump assembly such that the one or more inflatable bladders are in fluid communication with the second passage;
the first pump assembly defining a receptacle into which the second pump assembly is slidingly receivable while the one or more inflatable bladders are in fluid communication with the second passage, the sliding reception of the second pump assembly into the first pump assembly establishing fluid communication between the first and second pneumatic passages and establishing electrical communication between the first and second electrical contacts.

16. The therapeutic compression system of claim 15, wherein the fluid communication between the first and second pneumatic passages and the electrical communication between the first and second electrical contacts are simultaneously established by the sliding reception of the second pump assembly into the first pump assembly.
